(19) United States
(12) Patent Application Publication
(10) Pub. No.: US 2016/0006998 A1
(43) Pub. Date: Jan. 7, 2016

(54) IMAGE PROCESSING DEVICE AND METHOD THEREOF

(71) Applicant: Samsung Electronics Co., Ltd., Suwon-Si (KR)

(72) Inventors: Jinho LEE, Suwon-si (KR); Yookyung KIM, Daejeon-si (KR); Dong Kyung NAM, Yongin-si (KR)

(21) Appl. No.: 14/522,992

(22) Filed: Oct. 24, 2014

(30) Foreign Application Priority Data
Jul. 2, 2014 (KR) 10-2014-0082613

(51) Int. Cl. H04N 9/31

(52) U.S. Cl. CPC H04N 9/3182; H04N 9/3191

(57) ABSTRACT

An image correcting method includes capturing projected images, generating first captured images based on the capturing, analyzing a number of pixels depending on color intensities of colors of the first captured images, and correcting the first captured images based on the analyzing.

### CROSS-REFERENCE TO RELATED APPLICATION

This application claims the priority benefit of Korean Patent Application No. 10-2014-0082613, filed on Jul. 2, 2014, in the Korean Intellectual Property Office, the entire disclosure of which is incorporated herein by reference.

### BACKGROUND

1. Field

At least some example embodiments of the following description relate to an image processing device and an operating method of the image processing device.

2. Description of the Related Art

Recently, glass-type three-dimensional (3D) televisions (TVs) and nonglass-type 3D TVs have been provided as 3D contents are becoming more readily available.

The glass-type 3D TVs designed to provide a 3D image using polarized glasses may present an inconvenience to users in terms of a need to wear the glasses and an occurrence of visual fatigue during viewing due to an accommodation-vergence conflict.

The nonglass-type 3D TVs may apply a viewpoint-based imaging method through which a multi-view image is obtained using a lenticular lens and the like to provide a 3D image, and a light field-based imaging method through which two-dimensional (2D) images separately generated using a method of synthesizing light field rays are recombined to provide a 3D image.

A system for the viewpoint-based imaging method may experience a decrease in resolution of a display depending on a number of generated viewpoints and face limitations of a viewing angle and a viewing distance.

A system for the light field-based imaging method may increase a number of projectors to be disposed corresponding to directional components of light and secure a required resolution to achieve a high-resolution 3D image.

### SUMMARY

The foregoing and/or other aspects are achieved by providing an image processing method including capturing projected images, generating first captured images based on the capturing, analyzing a number of pixels depending on color intensities of colors of the first captured images, and correcting the first captured images based on the analyzing.

The capturing may include capturing projected images permeating a screen.

The capturing may include capturing projected images reflected from the screen.

The analyzing includes calculating the number of pixels depending on the color intensities of the first captured images, and the correcting includes, analyzing distributions of the colors, and correcting at least one of the colors and brightnesses of the first captured images based on the color intensities of the first captured images.

The correcting the at least one of the colors and brightness may include selecting a reference image from among the first captured images based on maximum values of the color intensities of the first captured images, and correcting the at least one of the colors and the brightnesses of the first captured images using the reference image.

The correcting of the at least one of the colors and the brightnesses of the first captured images using the reference image may include correcting the at least one of the colors and the brightnesses of the first captured images to be equalized based on a maximum value of a color intensity of the reference image and the maximum values of the color intensities of the first captured images.

The correcting of the at least one of the colors and the brightnesses of the first captured images using the reference image may include correcting the at least one of the colors and the brightnesses of the first captured images based on a number of pixels in each color intensity section of the reference image to a number of pixels in each color intensity section of the first captured images.

The analyzing of the color intensities may include determining an average maximum value of the maximum values of the color intensities of the first captured images, and correcting the at least one of the colors and the brightnesses of the first captured images based on the averaged maximum value.

The correcting may include analyzing distributions of the colors based on the number of pixels depending on the color intensities of the first captured images, adjusting at least one of an intensity value, a gain value, and a gamma value of the first captured images based on the analyzing, and correcting the at least one of the colors and the brightnesses of the first captured images based on the adjusting.

The selecting of the reference image may include selecting, as the reference image, a captured image having a smallest maximum value of a color intensity from among the first captured images.

The selecting of the reference image may include selecting, as the reference image, a captured image having a medium maximum value of a color intensity from among the first captured images.

The image processing method may further include generating an integrated image using the corrected first captured images and changing a brightness distribution of the integrated image generating a gray level image based on the changing, and generating an input image based on the gray level image.

The generating the gray level image may include functionalizing a gray level of the integrated image.

The image processing method may further include capturing the corrected first captured images, generating second captured images based on the capturing, extracting brightness distributions of the second captured images as a gray level, generating gray level images by changing the brightness distributions, and generating an input image based on the gray level images.

The image processing method may further include changing brightness distributions of the corrected first captured images, generating gray level images based on the changing, generating an input image based on the gray level images.

The generating of the gray level images may include generating the gray level images applying overall image, only an area in which a brightness distribution is present in the first captured images obtained by changing the brightness distributions.

The foregoing and/or other aspects are achieved by providing an image processing device including an image captures configured to capture projected images and generate first captured images, and an image calibrator configured to correct the first captured images based on analyzing a number of pixels depending on color intensities of colors of the first captured images.

The image calibrator is configured to analyze the color intensities by calculating the number of pixels and correct at least one of the colors and brightnesses of the first captured images based on the analyzing.

The image calibrator is configured to select a reference image from among the first captured images by based on maximum values of the color intensities of the first captured images and correct the at least one of the colors and the brightnesses of the first captured images using the reference image.

The image calibrator is configured to generate an integrated image using the corrected first captured images and generate a gray level image by changing a brightness distribution of the integrated image.

The image processing device may further include an image generator configured to generate an input image based on the gray level image.

The image calibrator is configured to generate gray level images by changing brightness distributions of the corrected first captured images.

Additional aspects of some example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating an example of a display system according to at least one exam pie embodiment;

FIG. 2 is a diagram illustrating an example of a display device of FIG. 1;

FIG. 3 is a diagram illustrating an example of an image processing device of FIG. 1;

FIG. 4 is a diagram illustrating an example of a captured image generated by a capturer of FIG. 3;

FIG. 5 is a graph illustrating a result of analyzing a distribution of a color of a captured image of FIG. 4;

FIG. 6 is a diagram illustrating an example of a method of generating each gray level image corresponding to each first captured image according to at least one example embodiment;

FIG. 7 is a flowchart illustrating an example of an operating method of an image processing device of FIG. 1;

FIG. 8 is a flowchart illustrating another example of an operating method of an image processing device of FIG. 1; and

FIG. 9 is a flowchart illustrating still another example of an operating method of an image processing device of FIG. 1.

### DETAILED DESCRIPTION

Reference will now made in detail to embodiments, examples of which are illustrated in the accompanying drawings, wherein like reference numerals refer to like elements throughout. Example embodiments are described below to explain the present disclosure by referring to the figures.

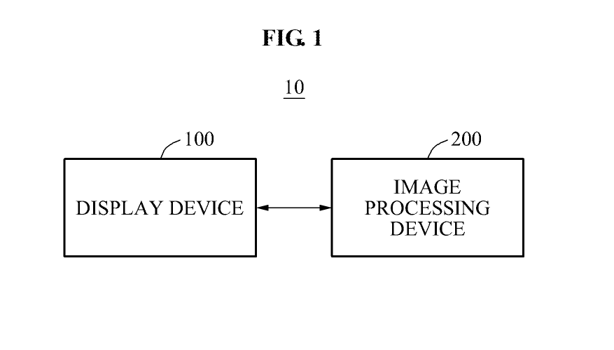

FIG. 1 is a diagram illustrating an example of a display system 10 according to at least one example embodiment.

Referring to FIG. 1, the display system 10 includes a display device 100 and an image processing device 200. For example, the display system 10 may be a nonglass-type three-dimensional (3D) display system.

The display device 100 generates a 3D image based on an input image transmitted from the image processing device 200. For example, the input image may be a two-dimensional (2D) image or a 3D image. The display device 100 may include all devices that may display an image and a display of a computer or a portable device. Alternatively, the display device 100 may be a light-field 3D display device.

The image processing device 200 controls an overall operation of the display system 10. The image processing device 200 may be designed as a printed circuit board (PCB) such as a motherboard, an integrated circuit (IC), or a system on chip (SoC). For example, the image processing device 200 may be an application processor.

The image processing device 200 generates the input image and transmits the input image to the display device 100 to allow the display device 100 to generate the 3D image based on the input image.

The image processing device 200 captures projected images and generates first captured images, and corrects the first captured images based on a result of analyzing a number of pixels based on color intensities of colors of the first captured images.

The image processing device 200 generates the input image based on the corrected first captured images.

In an example, the image processing device 200 generates an integrated image using the corrected first captured images, and generates a gray level image by inversely changing a brightness distribution of the integrated image. The image processing device 200 generates the input image based on the gray level image.

In another example, the image processing device 200 generates second captured images by simultaneously capturing the corrected first captured images, extracts a gray level based brightness distributions of the second captured images, and inversely changes the brightness distributions. The image processing device 200 generates gray level images by comprehensively applying, to a corresponding overall image, only an area in which a brightness distribution is present in the second captured images obtained by inversely changing the brightness distributions. The image processing device 200 generates the input image based on the gray level images.

Although FIG. 1 illustrates the image processing device 200 as an additional device externally and separately disposed from the display device 100, the image processing device 200 may be included in the display device 100 according to at least one example embodiment.

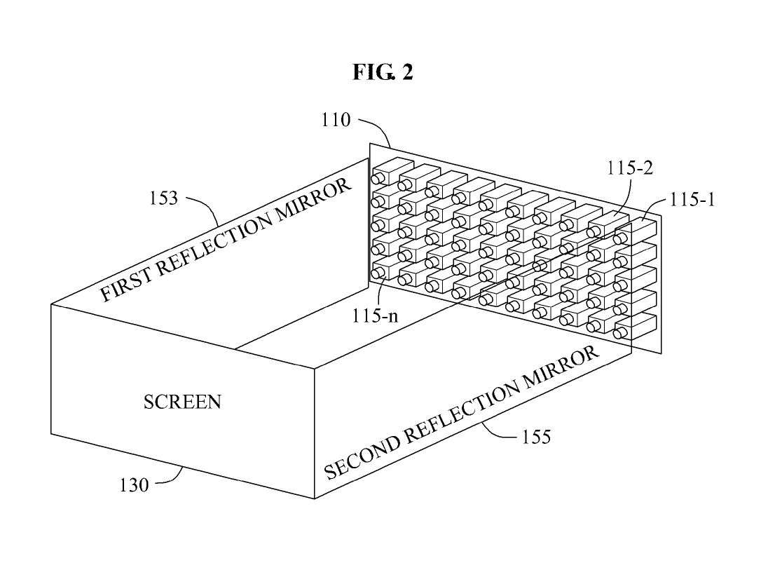

FIG. 2 is a diagram illustrating an example of the display device 100 of FIG. 1.

Referring to FIGS. 1 and 2, the display device 100 includes an optical module array 110, a screen 130, and reflection mirrors, for example, a first reflection mirror 153 and a second reflection mirror 155.

The optical module array 110 includes a plurality of optical modules, for example, 115-1 through 115-n, wherein “n” denotes a natural number greater than 1. For convenience of description, an operation of a single optical module, for example, an optical module 115-1, will be described hereinafter with reference to FIG. 2 because operations of the optical modules 115-1 through 115-n and operations associated with the optical modules 115-1 through 115-n are practically identical.

The optical module 115-1 outputs or projects the input image transmitted from the image processing device 200 to the screen 130. The optical module 115-1 emits at least one ray corresponding to the input image transmitted from the image processing device 200. For example, the input image may be used to form a light-field image, a multi-view image, or a super multi-view image to be a 3D image. The input image may be a 2D image or a 3D image.

For example, the optical module 115-1 may be designed as a projector. Alternatively, the optical module 115-1 may be designed as a microdisplay including a spatial light modulator (SLM).

The screen 130 displays the input image output from the optical module 115-1. The screen 130 displays at least one ray corresponding to the input image output from the optical module 115-1. For example, the screen 130 displays a 3D image generated through the at least one ray being synthesized or overlapped. Here, the screen 130 may be a vertical diffuser screen or an anisotropic diffuser screen.

The reflection minors 153 and 155 reflect, into the screen 130, rays deviating from the screen 130 among rays output from the optical module 115-1.

The first reflection minor 153 is disposed on a side of the screen 130, for example, on a left side of the screen 130, and reflects, into the screen 130, rays externally output to the left side of the screen 130. Similarly, the second reflection mirror 155 is disposed on another side of the screen 130, for example, on a right side of the screen 130, and reflects, into the screen 130, rays externally output to the right side of the screen 130.

In an example, the first reflection mirror 153 and the second reflection mirror 155 may be disposed vertical to the screen 130. The first reflection mirror 153 may be disposed to allow one side and another side of the first reflection mirror 153 to be vertical to both the optical module array 110 and the screen 130. Similarly, the second reflection minor 155 may be disposed to allow one side and another side of the second reflection mirror 155 to be vertical to both the optical module array 110 and the screen 130.

In another example, the first reflection mirror 153 and the second reflection mirror 155 may be tilted at a predetermined angle from a center of the screen 130. The first reflection mirror 153 may be disposed to allow one side and another side of the first reflection mirror 153 to form a first angle with the optical module array 110 and a second angle with the screen 130. Similarly, the second reflection mirror 155 may be disposed to allow one side and another side of the second reflection mirror 155 to form a third angle with the optical module array 110 and a fourth angle with the screen 130. In such an example, the first angle and the third angle may be identical to or different from each other. Similarly, the second angle and the fourth angle may be identical to or different from each other. Thus, the first reflection mirror 153 and the second reflection mirror 155 may reflect a ray output from the optical module 115-1 to the screen 130 by being tilted at the predetermined angle against the screen 130. Here, the predetermined angle may be settable.

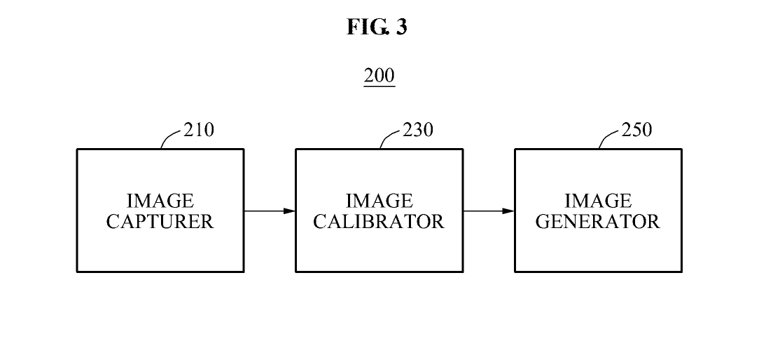

FIG. 3 is a diagram illustrating an example of the image processing device 200 of FIG. 1.

Referring to FIGS. 1 through 3, the image processing device 200 includes an image capturer 210, an image calibrator 230, and an image generator 250.

The image capturer 210, the image calibrator 230, and the image generator 250 may be hardware, firmware, hardware executing software or any combination thereof. When at least one of the image capturer 210, the image calibrator 230, and the image generator 250 is hardware, such existing hardware may include one or more Central Processing Units (CPUs), digital signal processors (DSPs), application-specific-integrated-circuits (ASICs), field programmable gate arrays (FPGAs) computers or the like configured as special purpose machines to perform the functions of the at least one of the image capturer 210, the image calibrator 230, and the image generator 250. CPUs, DSPs, ASICs and FPGAs may generally be referred to as processors and/or microprocessors.

In the event where at least one of the image capturer 210, the image calibrator 230, and the image generator 250 is a processor executing software, the processor is configured as a special purpose machine to execute the software, stored in a storage medium, to perform the functions of the at least one of the image capturer 210, the image calibrator 230, and the image generator 250. In such an embodiment, the processor may include one or more Central Processing Units (CPUs), digital signal processors (DSPs), application-specific-integrated-circuits (ASICs), field programmable gate arrays (FPGAs) computers.

The image capturer 210 captures projected images and generates first captured images. For example, the image capturer 210 sequentially captures the projected images and generates the first captured images. The projected images may be uniform toned color images without an image or a pattern included therein, and be output to the screen 130 from each of the optical modules 115-1 through 115-n.

The image capturer 210 may be designed as a camera, a video camera, and the like. Alternatively, the image capturer 210 may be designed as a digital camera including an image sensor or all imaging devices such as a camera module that may convert an optical image to an electronic signal.

For example, when the first optical module 115-1 outputs a projected image to the screen 130 the image capturer 210 generates a captured image by capturing the projected image. When a second optical module 115-2 outputs another projected image to the screen 130, the image capturer 210 generates another captured image by capturing the projected image. Similarly, when an n-th optical module 115-n outputs a still another projected image to the screen 130, the image capturer 210 generates the still another captured image by capturing the projected image. The image capturer 210 repeats the foregoing operation until all the first captured images are obtained by capturing the projected images output from the optical modules 115-1 through 115-n.

The image capturer 210 may be designed to satisfy viewing conditions. In an example, the image capturer 210 generates the first captured images by capturing projected images permeating the screen 130. In such an example, the image capturer 210 may be disposed in front of the screen 130. In another example, the image capturer 210 generates the first captured images by capturing projected images reflected from the screen 130. In such an example, the image capturer 210 may be disposed between the optical module array 110 and the screen 130.

The image capturer 210 transmits the first captured images to the image calibrator 230.

The image calibrator 230 analyzes a number of pixels based on color intensities of colors of the first captured images, and corrects the first captured images based on a result of the analyzing. The image calibrator 230 analyzes distributions of the colors by calculating the number of pixels of the colors of the first captured images. The colors may be at least one of red, green, and blue.

The image calibrator 230 corrects at least one of the colors and brightnesses of the first captured images to be equalized by adjusting at least one of an intensity value, a gain value, and a gamma value of the first captured images based on the result of the analyzing.

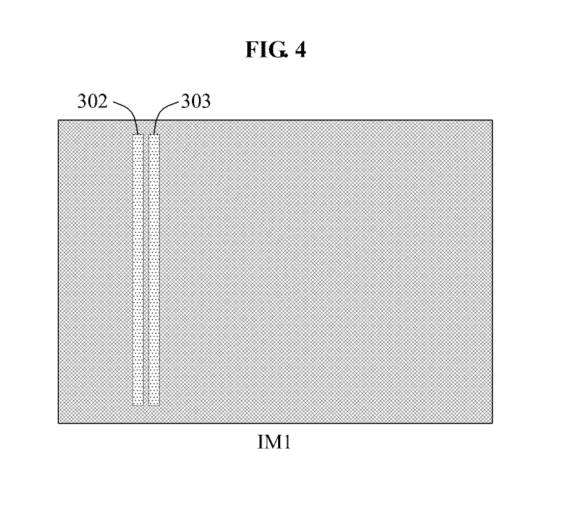

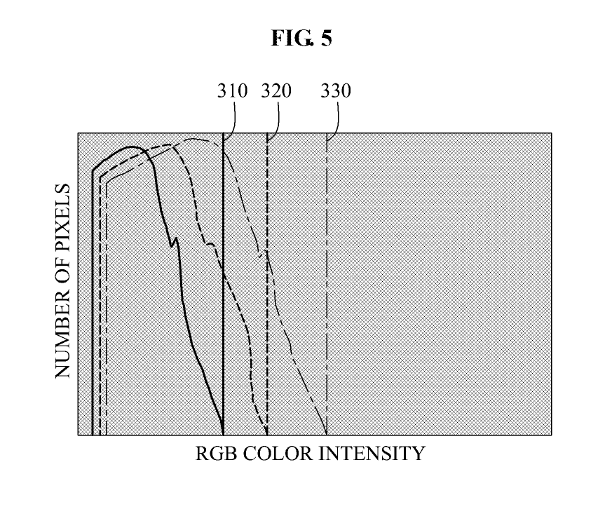

FIG. 4 is a diagram illustrating an example of a captured image generated by the image capturer 210 of FIG. 3, and FIG. 5 is a graph illustrating a result of analyzing a distribution of a color of the captured image of FIG. 4.

For convenience of description, FIG. 4 illustrates only an image obtained by capturing a projected image output from any one of optical modules, and FIG. 5 illustrates only a brightness distribution of a color, for example, red, green, and blue, of the captured image.

Referring to FIGS. 4 and 5, the projected image is indicated as a unit image block elongated to a vertical direction of the screen 130. An image IM1 of FIG. 4 captured by the image capturer 210 includes a unit image block 303. The unit image block 303 may be a directly projected image block to be directly displayed on the screen 130 based on the projected image. The image IM1 further includes a unit image block 302. The unit image block 302 may be a reflected projected image block generated through at least one of the reflection mirrors 153 and 155. Thus, the image IM1 includes the two unit image blocks 302 and 303. As illustrated in FIG. 4, a portion in the image IM1 from which the two unit image blocks 302 and 303 are excluded is indicated in black as being a portion at which the projected image cannot be viewed from the screen 130.

Also, FIG. 5 illustrates the brightness distribution of the color of the captured image illustrated in FIG. 4, which is obtained by the image calibrator 230.

Referring to FIG. 5, a line 310 indicates red, a line 320 indicates green, and a line 330 indicates blue. In this graph, points at which the lines 310, 320, and 330 meet a bottom of the graph indicate respective maximum values of color intensities of corresponding colors.

For convenience of description, an example in which the image calibrator 230 corrects at least one of the colors and the brightnesses of the first captured images to be equalized by adjusting color intensities will be hereinafter described.

Referring to FIGS. 1 through 5, the image calibrator 230 analyzes the color intensities of colors of the first captured images, and corrects at least one of the colors and the brightnesses of the first captured images to be equalized based on a result of the analyzing. For example, the image calibrator 230 adjusts maximum values of the color intensities of the first captured images to be equal and corrects the at least one of the colors and the brightnesses of the first captured images to be equal.

In an example, the image calibrator 230 compares the maximum values of the color intensities of the first captured images and selects a reference image from among the first captured images. For example, the image calibrator 230 selects, as the reference image, a captured image having a smallest maximum value of a color intensity from among the first captured images. For another example, the image calibrator 230 selects, as the reference image, a captured image having a medium maximum value of a color intensity from among the first captured images.

The image calibrator 230 corrects the at least one of the colors and the brightnesses of the first captured images to be equalized using the reference image. For example, the image calibrator 230 compared a maximum value of a color intensity of the reference image to the maximum values of the color intensities of the first captured images and correct the at least one of the colors and the brightnesses of the first captured images to be equalized. For another example, the image calibrator 230 compares a number of pixels in a color intensity section of the reference image to a number of pixels in a color intensity section of the first captured images, and corrects the at least one of the colors and the brightnesses of the first captured images to be equalized.

In another example, the image calibrator 230 averages the maximum values of the color intensities of the first captured images. The image calibrator 230 corrects the at least one of the colors and the brightnesses of the first captured images to be equalized based on the averaged maximum value.

When the maximum values of the color intensities of the first captured images are equalized, maximum intensities and color, for example, color temperatures, of unit image blocks of the first captured images, for example, a directly projected image block and a reflected projected image block, may be equalized.

The image calibrator 230 generates a gray level image and/or gray level images using the corrected first captured images.

In an example, the image calibrator 230 generates the gray level images by inversely changing brightness distributions of the corrected first captured images. For example, the image calibrator 230 inversely changes the brightness distributions of the corrected first captured images, and generates the gray level images by comprehensively applying, to a corresponding overall image, only an area in which a brightness distribution is present in the first captured images obtained by inversely changing the brightness distributions.

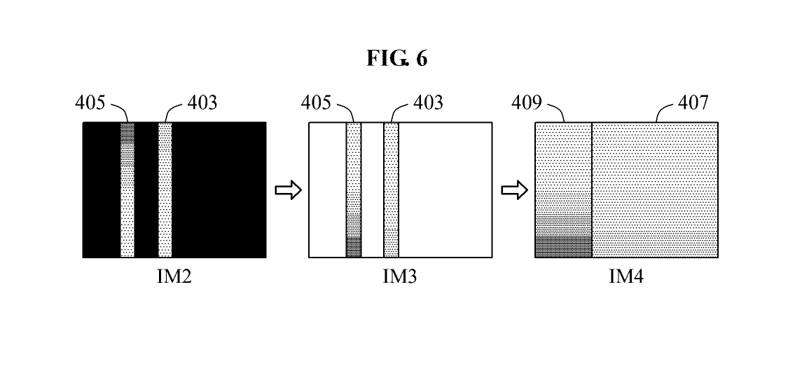

FIG. 6 is a diagram illustrating an example of a method of generating each gray level image corresponding to each first captured image according to at least one example embodiment.

For convenience of description, FIG. 6 illustrates only one captured image IM2 among the first captured images.

Referring to FIG. 6, the image calibrator 230 extracts a gray level based brightness distribution of the captured image IM2. The captured image IM2 illustrated in FIG. 6 includes a directly projected image block 403 and a reflected projected image block 405. The directly projected image block 403 and the reflected projected image block 405 may be identical to the descriptions provided with reference to FIG. 4. In an example, the image calibrator 230 inversely changes the brightness distribution of the captured image IM2. For example, the image calibrator 230 changes a dark background, excluding the two image blocks 403 and 405, to a bright background. In addition, the image calibrator 230 inversely changes a brightness distribution in the two image blocks 403 and 405. The image calibrator 230 generates a gray level image IM4 by comprehensively applying, to an overall image, only an area in which a brightness distribution is present in a captured image IM3 obtained by changing the brightness distribution, for example, the two image blocks 403 and 405. As illustrated in FIG. 6, the gray level image IM4 includes a directly projected image area 407 to which the directly projected image block 403 is expansively applied and a reflected projected image area 409 to which the reflected projected image block 405 is expansively applied.

In another example, the image calibrator 230 generates an integrated image using the corrected first captured images, and generates a gray level image obtained by inversely changing a brightness distribution of the integrated image. For example, the image calibrator 230 inversely changes the brightness distribution of the integrated image, and generates the gray level image by functionalizing a gray level of the integrated image. The image calibrator 230 generates the gray level image to be used for correcting an image, for example, a 3D image, to be actually reproduced by the optical modules 115-1 through 115-n.

In still another example, the image calibrator 230 extracts gray level based brightness distributions of second captured image obtained by simultaneously capturing the corrected first captured images, and inversely changes the brightness distributions. In such an example, the optical modules 115-1 through 115-n output the corrected first captured images to the screen 130, and the image capturer 210 generates the second captured images by capturing the corrected first captured images and transmits the second captured images to the image calibrator 230. The corrected first captured images are rendered by the image generator 250 prior to the corrected first captured images being output to the screen 130 through the optical modules 115-1 through 115-n. The image calibrator 230 generates each gray level image to correct each image to be actually reproduced by each of the optical modules 115-1 through 115-n.

Referring to FIGS. 1 through 6, the image calibrator 230 transmits the gray level image and/or the gray level images to the image generator 250. In addition, the image calibrator 230 transmits the corrected first captured images to the image generator 250.

The image generator 250 generates an input image based on the gray level image and/or the gray level images. The image generator 250 generates the input image by synthesizing the gray level image and/or the gray level images and an image to be actually reproduced. In addition, the image generator 250 generates the input image by synthesizing the corrected first captured images and the image to be actually reproduced. For example, the input image may be individual images corresponding to each of the optical modules 115-1 through 115-n. Also, the input image may be an overall image to which the individual images corresponding to each of the optical module 115-1 through 115-n are synthesized.

The image generator 250 may be designed as a graphics real-time rendering module.

According to at least one example embodiment, the image processing device 200 may generate the input image of the optical modules 115-1 through 115-n based on the first captured images in which at least one of colors and brightnesses is corrected and equalized. Thus, the image processing device 200 may generate a clear 3D image in which inequality is compensated for in a color and a brightness of the image that may be caused by a difference in brightnesses and color temperatures of the optical modules 115-1 through 115-n and a difference in color temperatures due to a configuration of the display system 10.

In addition, according to at least one example embodiment, the image processing device 200 may generate the input image of the optical modules 115-1 through 115-n based on the gray level image or the gray level images to which brightness information is inversely applied. Thus, the image processing device 200 may generate a clear 3D image in which inequality is compensated for in a color and a brightness of the image that may be caused by a difference in locations at which the optical modules 115-1 through 115-n are disposed, a scattering characteristic of the screen 130, a difference in reflectances of reflection mirrors, and the like.

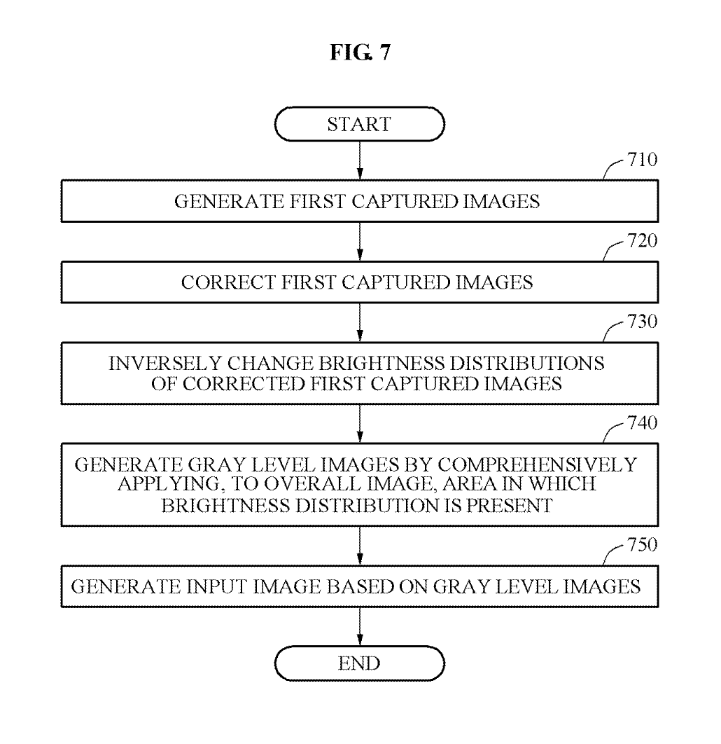

FIG. 7 is a flowchart illustrating an example of an operating method of the image processing device 200 of FIG. 1.

Referring to FIG. 7, in operation 710, the image processing device 200 generates first captured images by capturing projected images.

In operation 720, the image processing device 200 corrects the first captured images based on a result of analyzing a number of pixels depending on color intensities of colors of the first captured images.

In operation 730, the image processing device 200 inversely changes brightness distributions of the corrected first captured images.

In operation 740, the image processing device 200 generates gray level images by comprehensively applying, to an overall image, only an area in which a brightness distribution is present in the first captured images obtained by inversely changing the brightness distributions.

In operation 750, the image processing device 200 generates an input image based on the gray level images.

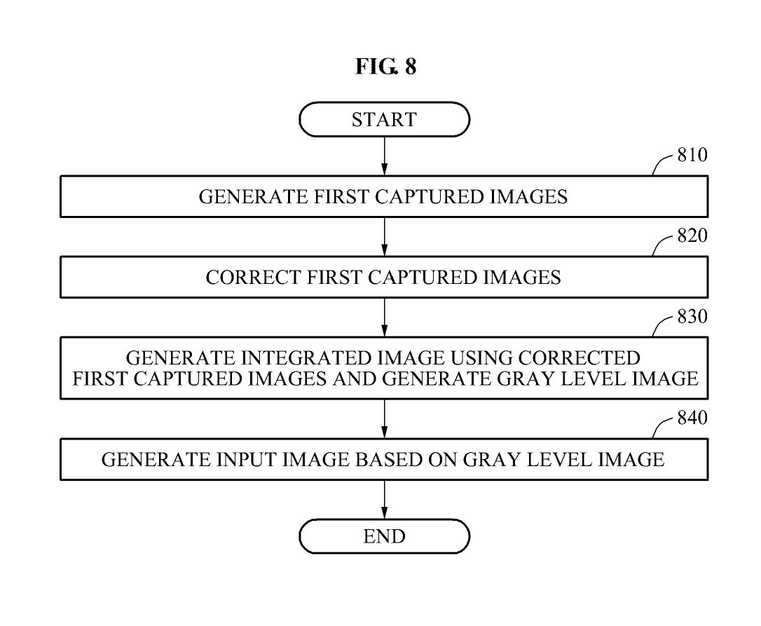

FIG. 8 is a flowchart illustrating another example of an operating method of the image processing device 200 of FIG. 1.

Referring to FIG. 8, in operation 810, the image processing device 200 generates first captured images by capturing projected images.

In operation 820, the image processing device 200 corrects the first captured images based on a result of analyzing a number of pixels depending on color intensities of colors of the first captured images.

In operation 830 the image processing device 200 generates an integrated image using the corrected first captured images, and generates a gray level image by inversely changing a brightness distribution of the integrated image.

In operation 840, the image processing device 200 generates an input image based on the gray level image.

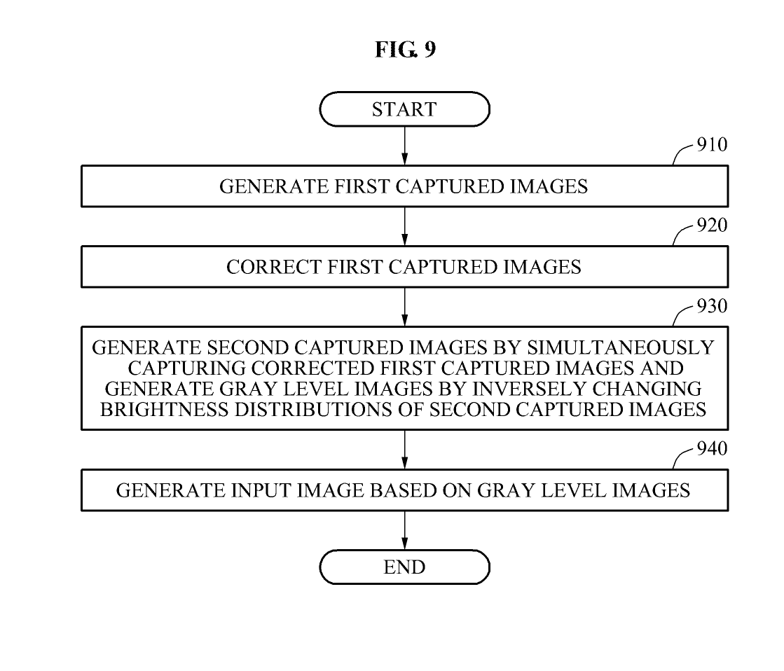

FIG. 9 is a flowchart illustrating still another example of an operating method of the image processing device 200 of FIG. 1.

Referring to FIG. 9, in operation 910, the image processing device 200 generates first captured images by capturing projected images.

In operation 920, the image processing device 200 corrects the first captured images based on a result of analyzing a number of pixels depending on color intensities of colors of the first captured images.

In operation 930, the image processing device 200 generates gray level images by generating second captured images by simultaneously capturing the corrected first captured images, extracting gray level based brightness distributions of the second captured images, and inversely changing the brightness distributions.

In operation 940, the image processing device 200 generates an input image based on the gray level images.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents.

What is claimed is:

1. An image processing method comprising:
capturing projected images;
generating first captured images based on the capturing;
analyzing a number of pixels depending on color intensities of colors of the first captured images; and
correcting the first captured images based on the analyzing.

2. The method of claim 1, wherein the capturing comprises:
capturing projected images permeating a screen.

3. The method of claim 1, wherein the capturing comprises:
capturing projected images reflected from a screen.

4. The method of claim 1, wherein
the analyzing includes,
calculating the number of pixels depending on the color intensities of the first captured images, and
analyzing distributions of the colors, and the correcting includes,
correcting at least one of the colors and brightnesses of the first captured images based on the color intensities of the first captured images.

5. The method of claim 4, wherein the correcting the at least one of the colors and brightness comprises:
selecting a reference image from among the first captured images based on maximum values of the color intensities of the first captured images; and
correcting the at least one of the colors and the brightnesses of the first captured images using the reference image.

6. The method of claim 5, wherein the correcting of the at least one of the colors and the brightnesses of the first captured images comprises:
correcting the at least one of the colors and the brightnesses of the first captured images based on a maximum value of a color intensity of the reference image and the maximum values of the color intensities of the first captured images.

7. The method of claim 5, wherein the correcting of the at least one of the colors and the brightnesses of the first captured images using the reference image comprises:
correcting the at least one of the colors and the brightnesses of the first captured images based on a number of pixels in each color intensity section of the reference image and a number of pixels in each color intensity section of the first captured images.

8. The method of claim 4, wherein the analyzing of the color intensities comprises:
determining an average maximum value of the maximum values of the color intensities of the first captured images; and
correcting the at least one of the colors and the brightnesses of the first captured images based on the average maximum value.

9. The method of claim 1, wherein the correcting comprises:
analyzing distributions of the colors based on the number of pixels depending on the color intensities of the first captured images;
adjusting at least one of an intensity value, a gain value, and a gamma value of the first captured images based on the analyzing the distributions; and
correcting at least one of the colors and brightnesses of the first captured images based on the adjusting.

10. The method of claim 1, further comprising:
generating an integrated image using the corrected first captured images;
changing a brightness distribution of the integrated image;
generating a gray level image based on the changing; and
generating an input image based on the gray level image.

11. The method of claim 10, wherein the generating the gray level image comprises:
functionalizing a gray level of the integrated image.

12. The method of claim 1, further comprising:
capturing the corrected first captured images;
generating second captured images based on the capturing the corrected first capture images;
extracting brightness distributions of the second captured images as a gray level;
generating gray level images by changing the brightness distributions; and
generating an input image based on the gray level images.

13. The method of claim 1, further comprising:
changing brightness distributions of the corrected first captured images;
generating gray level images based on the changing;
generating an input image based on the gray level images.

14. The method of claim 13, wherein the generating the gray level images comprises:
generating the gray level images for an area in which a brightness distribution is present in the first captured images after the changing.

15. An image processing device, comprising:
an image capturer configured to capture projected images and generate first captured images; and
an image calibrator configured to correct the first captured images by analyzing a number of pixels depending on color intensities of colors of the first captured images.

16. The device of claim 15, wherein the image calibrator is configured to analyze the color intensities by calculating the number of pixels and correct at least one of the colors and brightnesses of the first captured images based on the analyzing.

17. The device of claim 16, wherein the image calibrator is configured to select a reference image from among the first captured images based on maximum values of the color intensities of the first captured images and correct the at least one of the colors and the brightnesses of the first captured images using the reference image.

18. The device of claim 15, wherein the image calibrator is configured to generate an integrated image using the corrected first captured images and generate a gray level image by changing a brightness distribution of the integrated image.

19. The device of claim 15, further comprising:
an image generator configured to generate an input image based on the gray level image.

20. The device of claim 15, wherein the image calibrator is configured to generate gray level images by changing brightness distributions of the corrected first captured images.
